(19) United States
(12) Patent Application Publication
(10) Pub. No.: US 2007/0229597 A1
(43) Pub. Date: Oct. 4, 2007

(54) Liquid ejection head and image forming apparatus

(75) Inventor: Kenichi Kodama, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/730,123

(22) Filed: Mar. 29, 2007

(30) Foreign Application Priority Data
Mar. 30, 2006 (JP) 2006-095815

(51) Int. Cl. B41J 2/04

(52) U.S. Cl. 347/54

(57) ABSTRACT

The liquid ejection head includes: a nozzle plate formed with a nozzle through which a droplet of liquid is ejected; a liquid chamber which contains the liquid and is connected to the nozzle; and a pressure generating device which causes the liquid chamber to contract and expand, wherein: the nozzle has a first portion having a first diameter on a side from which the liquid is ejected, and a second portion having a second diameter on a side from which the liquid is supplied from the liquid chamber, the second diameter being not less than 2.5 times and not more than 5 times the first diameter; a non-wetting surface is formed on the nozzle plate at an inner face of the first portion of the nozzle and a face that contacts an outside air; a wetting surface is formed on an inner face of the nozzle other than the inner face of the first portion; and when starting ejection of the droplet of the liquid from the nozzle, force applied to the liquid inside the liquid chamber by the pressure generating device acts only in a direction which contracts volume inside the liquid chamber.

### BACKGROUND OF THE INVENTION

1. Field of the Invention

The present invention relates to a liquid ejection head and an image forming apparatus, and more particularly, to a liquid ejection head and an image forming apparatus capable of ejecting a liquid of high viscosity, as very small liquid droplets, at a short cycle.

2. Description of the Related Art

As an image forming apparatus, an inkjet recording apparatus or inkjet printer is known, which includes a liquid ejection head or inkjet printer head having an arrangement of a plurality of liquid ejection nozzles and which records an image on a recording medium by ejecting liquid or ink from the nozzles toward the recording medium while causing the inkjet head and the recording medium to move relatively to each other.

The inkjet head of the inkjet printer has pressure generating units, each including, for example, a pressure chamber to which ink is supplied from an ink tank through an ink supply channel, a piezoelectric element which is driven by an electrical signal in accordance with image data, a diaphragm which serves as a portion of the pressure chamber and deforms in accordance with the driving of the piezoelectric element, and a nozzle which is connected to the pressure chamber and from which the ink inside the pressure chamber is ejected in the form of a droplet due to the volume of the pressure chamber being reduced by the deformation of the diaphragm. In the inkjet printer, one image is formed on a recording medium by combining dots formed by the ink droplets ejected from the nozzles of the pressure generating units.

In the inkjet printer, information is recorded by ejecting ink directly from very fine nozzles, and therefore, in order to increase the definition of the image, various methods have been proposed to eject very small liquid droplets and/or to use liquid of high viscosity.

Japanese Patent Application Publication No. 57-131568 discloses an inkjet recording apparatus which is capable of ejecting ink stably by including nozzles which have a two-step diameter, and providing a hydrophilic part and a hydrophobic part inside each nozzle. However, the nozzle diameter is the same in the hydrophilic part and the hydrophobic part, and hence there is no beneficial effect for promoting refilling, and it is possible that the ejection frequency may decline due to the narrowing of the nozzle diameter.

Japanese Patent Application Publication No. 2000-238267 discloses technology which facilitates separation of the liquid droplets from the nozzles, by forming heaters about the periphery of the nozzles and driving these heaters at the time of separation of the liquid droplets. However, it is necessary to form the heater in each of the nozzles, and hence there are problems in that the structure is complicated and the manufacturing costs are high.

Japanese Patent Application Publication No. 2001-187451 discloses nozzles having a two-step diameter, in which the angle of taper of the nozzle differs between the ink ejection side (the side facing the external air), and the ink inlet side (the side facing the liquid). However, although beneficial effects are obtained in improving the ejection direction, if the nozzle diameter is reduced in order to eject small liquid droplets, then refilling becomes slower and the ejection frequency declines.

### SUMMARY OF THE INVENTION

The present invention has been contrived in view of the foregoing circumstances, an object thereof being to provide a structure for a liquid ejection head which is uncomplicated and prevents decline in the ejection frequency, even if the nozzle diameter is narrowed.

In order to attain the aforementioned object, the present invention is directed to a liquid ejection head, comprising: a nozzle plate formed with a nozzle through which a droplet of liquid is ejected; a liquid chamber which contains the liquid and is connected to the nozzle; and a pressure generating device which causes the liquid chamber to contract and expand, wherein: the nozzle has a first portion having a first diameter on a side from which the liquid is ejected, and a second portion having a second diameter on a side from which the liquid is supplied from the liquid chamber, the second diameter being not less than 2.5 times and not more than 5 times the first diameter; a non-wetting surface is formed on the nozzle plate at an inner face of the first portion of the nozzle and a face that contacts an outside air; a wetting surface is formed on an inner face of the nozzle other than the inner face of the first portion; and when starting ejection of the droplet of the liquid from the nozzle, force applied to the liquid inside the liquid chamber by the pressure generating device acts only in a direction which contracts volume inside the liquid chamber.

In order to attain the aforementioned object, the present invention is also directed to a liquid ejection head, comprising: a nozzle plate formed with a nozzle through which a droplet of liquid is ejected; a liquid chamber which contains the liquid and is connected to the nozzle; and a pressure generating device which causes the liquid chamber to contract and expand, wherein: the nozzle has a first portion having a first diameter on a side from which the liquid is ejected, and a second portion having a shape tapered from the liquid chamber to the first portion, an angle formed by an inner surface of the first portion and an inner surface of the second portion being not less than 90° and not more than 120°; a non-wetting surface is formed on the nozzle plate at an inner face of the first portion of the nozzle and a face that contacts an outside air; a wetting surface is formed on an inner face of the nozzle other than the inner face of the first portion; and when starting ejection of the droplet of the liquid from the nozzle, force applied to the liquid inside the liquid chamber by the pressure generating device acts only in a direction which contracts volume inside the liquid chamber.

In order to attain the aforementioned object, the present invention is also directed to an image forming apparatus comprising the above-described liquid ejection head.

According to the present invention, it is possible to provide a liquid ejection head which prevents decline in the ejection frequency, even if the nozzle diameter is narrowed, without adopting a complicated structure, and hence beneficial effects are obtained in that very small liquid droplets can be ejected at high frequency. Furthermore, beneficial effects are also obtained in that liquid droplets can be ejected without reducing the ejection frequency, even in the case of a liquid of high viscosity.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIGS. 1A to 1D are illustrative diagrams of the initial stage of a pull ejection method for ejecting ink;

FIGS. 2A to 2E are illustrative diagrams of the latter stage of the pull ejection method;

FIGS. 3A to 3C are illustrative diagrams of the initial stage of a push ejection method for ejecting ink;

FIGS. 4A to 4E are illustrative diagrams of the latter stage of the push ejection method;

FIG. 5 is a cross-sectional diagram of the structure of a nozzle section of a liquid ejection head according to an embodiment of the present invention;

FIG. 6 is a cross-sectional diagram of the structure of the nozzle section, in order to explain the principles of the present invention;

FIG. 7 is a diagram showing the relationship between a nozzle diameter in a second nozzle plate and a refill time;

FIG. 8 is a cross-sectional diagram of the structure of another nozzle section, in order to explain further principles of the present invention;

FIG. 9 is a diagram showing the relationship between a taper angle of a nozzle region in the second nozzle plate and the refill time;

FIG. 10 is a general schematic drawing of an image forming apparatus according to an embodiment of the present invention;

FIG. 11 is a principal plan diagram of the periphery of a print unit in the image forming apparatus;

FIGS. 12A to 12C are plan view perspective diagrams showing embodiments of the composition of a liquid ejection head in the image forming apparatus;

FIG. 13 is a cross-sectional diagram of the liquid ejection head;

FIG. 14 is a drive waveform diagram for the liquid ejection head;

FIG. 15 is a further drive waveform diagram for the liquid ejection head;

FIG. 16 is a schematic drawing showing an approximate view of an ink supply system for the liquid ejection head;

FIG. 17 is a principal block diagram showing the system configuration of the image forming apparatus;

FIG. 18 is a diagram of the relationship between T2/D2 and the refill time; and

FIG. 19 is a diagram of the relationship between D2/D1 and T2/D2.

### DETAILED DESCRIPTION OF THE PREFERRED EMBODIMENTS

### Principles and Concepts

The principles and concepts of the present invention are described.

Firstly, ejection methods used to eject ink from nozzles of a liquid ejection head are described.

The methods for ejecting ink from the nozzles of the liquid ejection head include a pull ejection method and a push ejection method.

In the pull ejection method, a free surface of the ink (the liquid-atmosphere interface, which is also commonly called “meniscus”) inside the nozzle is firstly pulled in the direction of the ink in the nozzle, and then the ink is ejected by applying a force to the ink in the direction of ejection.

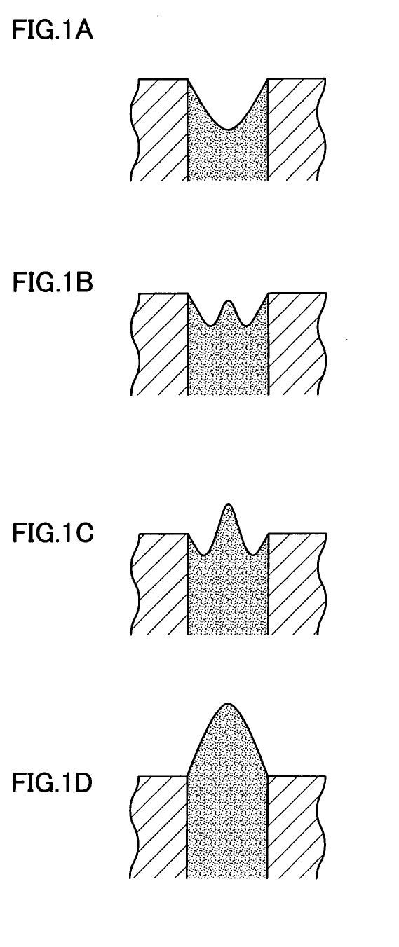

The pull ejection method is described in more specific terms with reference to FIGS. 1A to 1D.

Firstly, in the pull ejection method, the free surface of the ink is pulled temporarily in the direction in which the ink is present, as shown in FIG. 1A. In this state, the free surface of the ink assumes a recessed shape. Thereupon, by applying a force in the direction in which the ink is to be ejected, the central portion of the free surface of the ink is made to assume a protuberant shape, as shown in FIG. 1B. Subsequently, as shown in FIG. 1C, the protuberance in the central part increases further, and the whole of the free surface of the ink assumes a projecting shape, as shown in FIG. 1D.

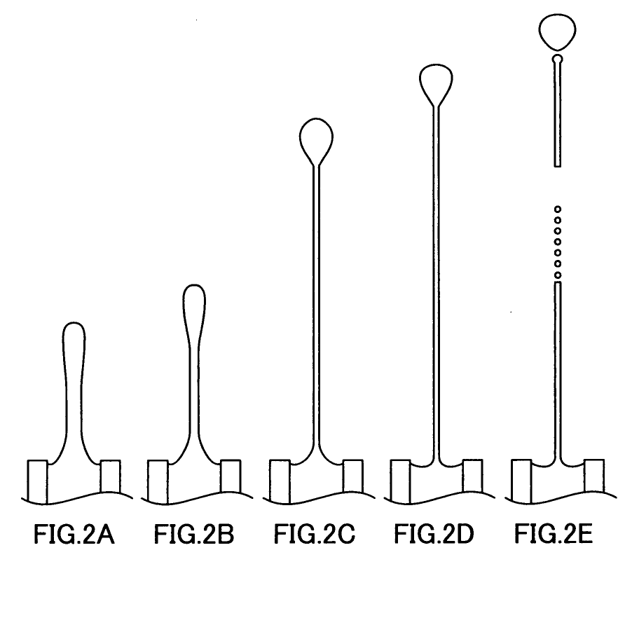

As this process progresses further, the ink is ejected. FIGS. 2A to 2E show the ejection of the ink. After the whole of the free surface of the ink has assumed the projecting shape as shown in FIG. 1D, the ink in the front end portion travels forward and a column of the ink is formed as shown in FIG. 2A. Thereupon, the process progresses as shown in FIGS. 2B, 2C and 2D, in which as the ink column gradually grows, the front end portion forms a substantially spherical shape. Eventually, as shown in FIG. 2E, the front end portion of the ink column breaks off, forming a droplet of the ink, and is ejected from the nozzle.

The pull ejection method is capable of ejecting small droplets, but when using ink of high viscosity, satellite droplets occur when the main droplet breaks off, and these satellite droplets cause deterioration of the quality of the image formed on the recording medium, such as paper.

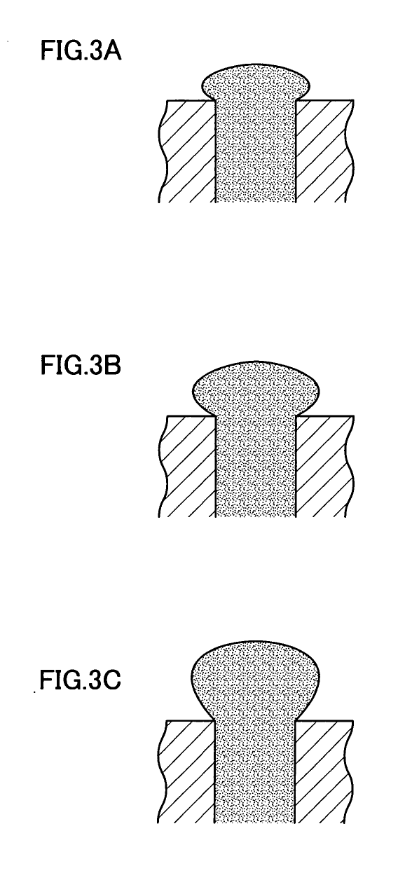

Next, the push ejection method is described with reference to FIGS. 3A to 3C.

In the push ejection method, in contrast to the pull ejection method, the ink is pushed out directly, without once pulling the free surface of the ink in the direction where the ink is situated.

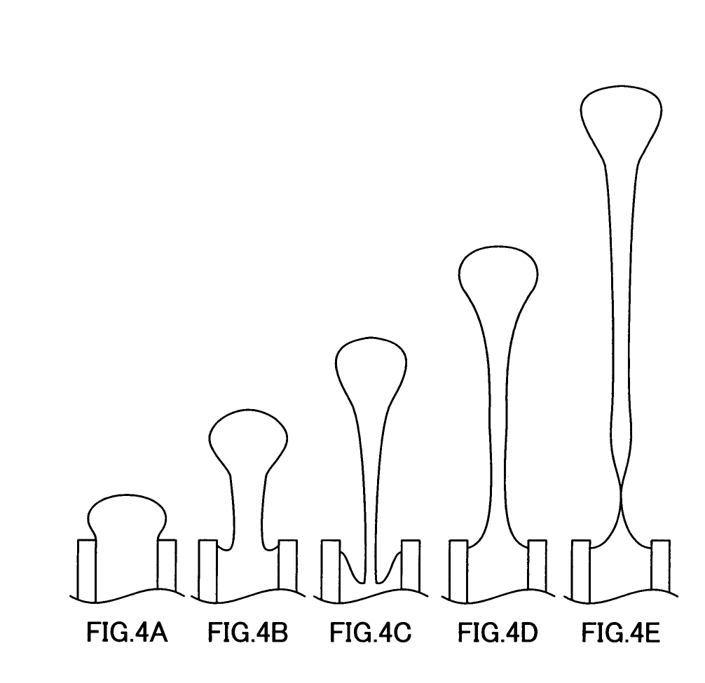

More specifically, by applying a force in the direction in which the ink is to be ejected as shown in FIG. 3A, the ink is gradually pushed out in the direction of the ejection, as shown in FIGS. 3B and 3C. Thereupon, the process progresses as shown in FIGS. 4A, 4B, 4C and 4D, and a column of the ink is formed. Subsequently, as shown in FIG. 4E, the ink column grows further, until eventually, the ink in the front end portion of the ink column breaks off, forming a droplet of the ink, which is ejected from the nozzle.

The push ejection method is not suitable for ejecting small droplets; however, since it does not generate any satellite droplets, even in the case of ink of high viscosity, it has the advantage that the quality of the image formed on the recording medium, such as paper, is not degraded by any satellite droplets.

Therefore, in order to achieve high-definition printing by using ink of high viscosity, it should be possible to eject small droplets of the ink by using the push ejection method. One method of ejecting small droplets is to narrow the diameter of the nozzles; however, as the nozzle diameter becomes smaller, the supply (refilling) of the ink after ejection of the ink tends to become slower, and hence there is a drawback in that a method of this kind is not suitable for high-speed printing.

FIG. 5 shows the composition of a nozzle 51 of a liquid ejection head according to an embodiment of the present invention.

As shown in FIG. 5, the nozzle 51 is formed in two nozzle plates: a first nozzle plate 59 and a second nozzle plate 60. The diameter D2 of the nozzle formed in the second nozzle plate 60 is larger than the diameter D1 of the nozzle formed in the first nozzle plate 59. A non-wetting region 61 forms a non-wetting surface on the face of the first nozzle plate 59 that makes contact with the outside air (i.e., the front face in the direction of liquid ejection (the direction indicated with an arrow)), and also on a region of the nozzle 51 formed in the first nozzle plate, which region is parallel with the liquid ejection direction. On the other hand, a wetting region 62 forms a wetting surface on the face of the first nozzle plate 59 that makes contact with the ink (i.e., the reverse face in the direction of liquid ejection), and also on a region of the nozzle 51 formed in the second nozzle plate 60, which region is parallel with the liquid ejection direction. By adopting this composition, in a steady state, the free surface 63 of the ink lies in contact with the nozzle 51 at the boundary section between the non-wetting region 61 and the wetting region 62.

Next, the results of a simulation into the relationship between the nozzle diameter D2 in the second nozzle plate 60, and the refill time, is described.

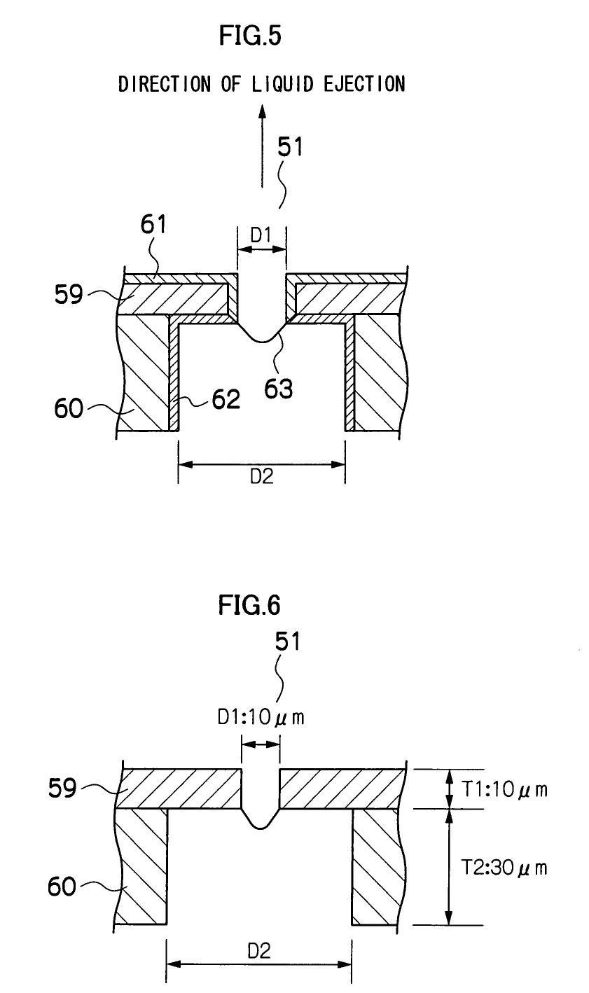

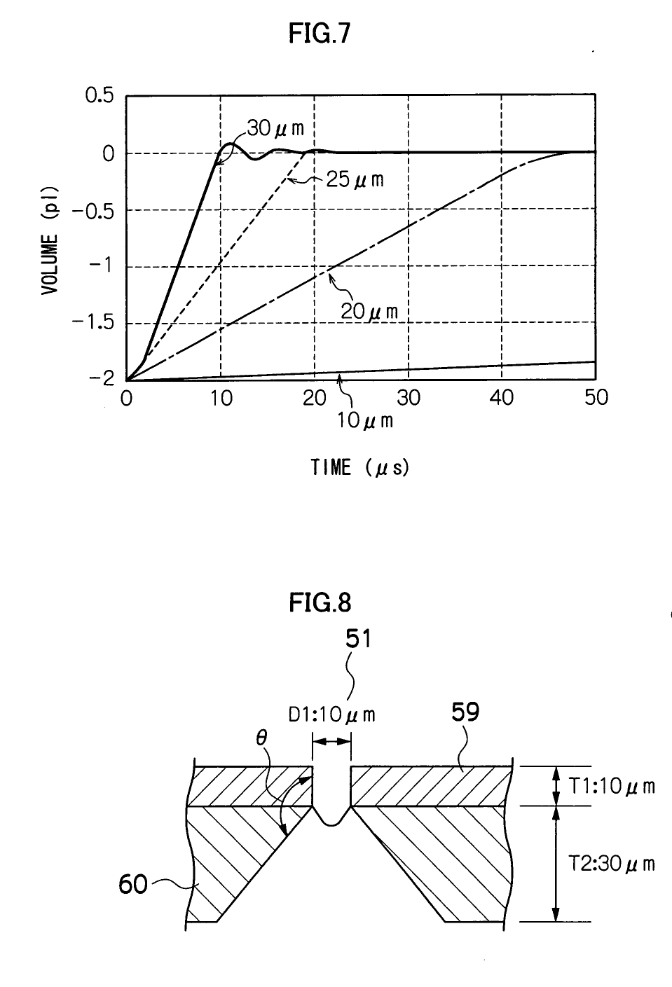

As shown in FIG. 6, the nozzle 51 is formed in the first nozzle plate 59, which has the thickness T1 of 10 μm and is formed with a hole serving as the nozzle region of the nozzle diameter D1 of 10 μm, and the second nozzle plate 60, which has the thickness T2 of 30 μm and is formed with a hole serving as the nozzle region of the nozzle diameter D2. The nozzle region in the first nozzle plate 59 and the nozzle region in the second nozzle plate 60 are each parallel to the liquid ejection direction. In FIG. 6, the non-wetting region 61 and the wetting region 62 are not shown in the drawing. FIG. 7 shows the refilling characteristics in relation to variation in the nozzle diameter D2 of the second nozzle plate 60.

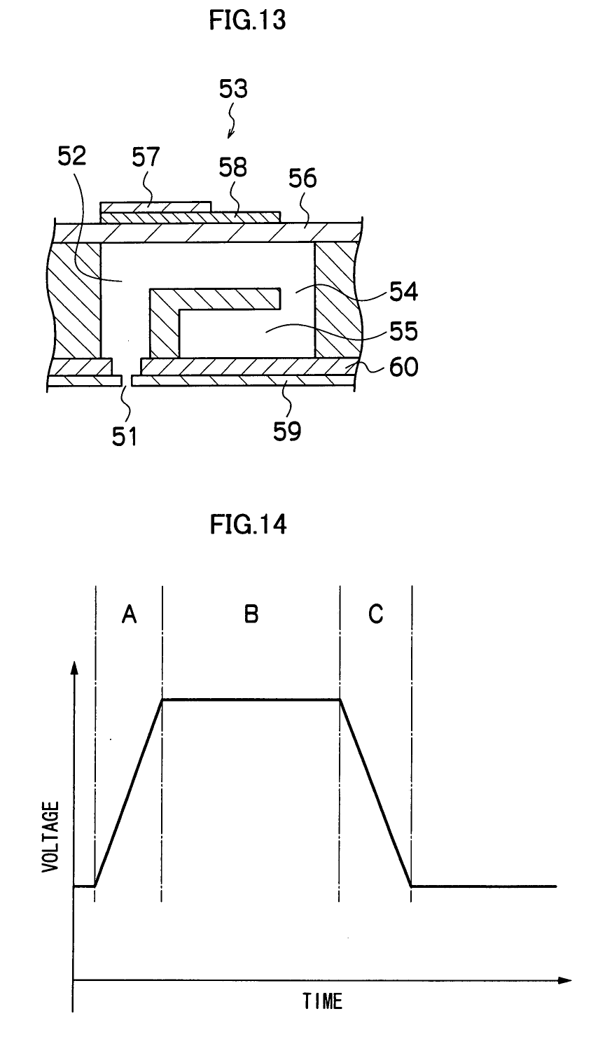

FIG. 7 shows the time period required to supply the ink to cover the shortage of the ink in the pressure chamber 52 immediately after the ink has been ejected from the nozzle 51. Approximately 2 picoliters (pl) of the ink is ejected in each ejection action, then immediately after the ejection of the ink, there is a corresponding shortage of the ink, in other words, the ink volume of −2 pl, in a pressure chamber 52 (see FIG. 13). Subsequently, refilling starts, and the refilling is completed when the volume of the ink shortage becomes 0 pl, in which state the next ink ejection operation can be carried out.

The physical values of the ink used in the simulation are: the viscosity coefficient μ: 2.0×10⁻² Pa·s, the density ρ: 1000 kg/m³, the sonic speed c: 1500 m/s, and the surface tension σ: 3.5×10⁻² N/m.

As shown in FIG. 7, as the nozzle diameter D2 in the second nozzle plate 60 becomes larger, the refill time tends to become shorter. At present, high-frequency driving is carried out in an inkjet head at 40 kHz to 50 kHz, and in order to correspond to this frequency, refilling must be completed in at least 20 μs. In order to satisfy this condition, the nozzle diameter D2 in the second nozzle plate 60 must be equal to or greater than 25 μm. Since the nozzle diameter D1 in the first nozzle plate 59 is 10 μm, then the condition for achieving high-frequency driving is that the nozzle diameter D2 in the second nozzle plate 60 must be 2.5 or more times the nozzle diameter D1 of the first nozzle plate 59.

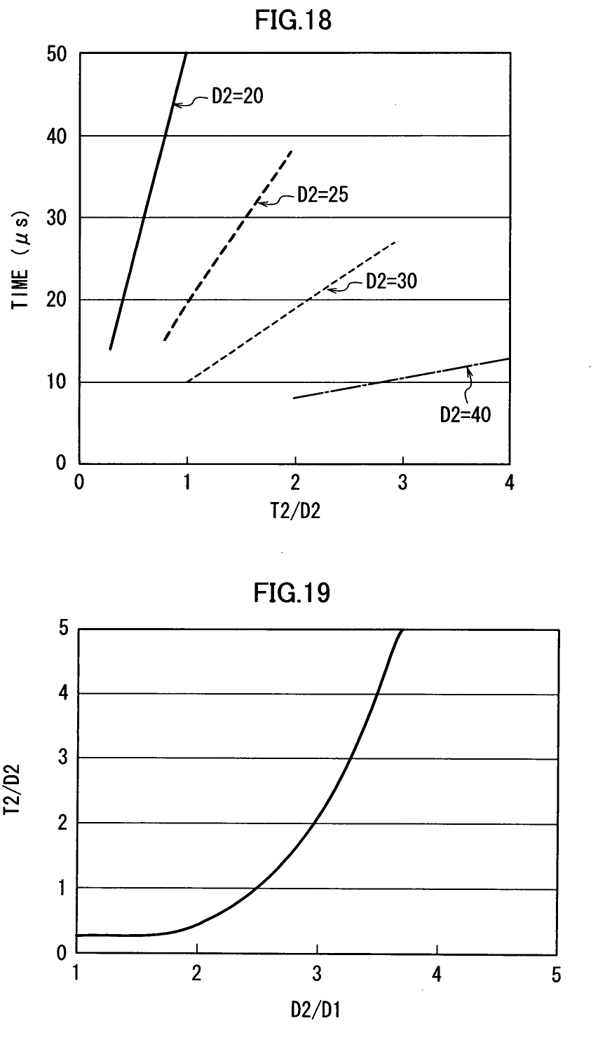

Furthermore, FIG. 18 shows the relationship between the refill time and the ratio T2/D2, between the thickness T2 of the second nozzle plate 60 and the nozzle diameter D2 in the second nozzle plate 60, in a case where the nozzle diameter D1 in the first nozzle plate 59 is 10 μm and the thickness T2 of the second nozzle plate 60 is 30 μm. In order to achieve high-frequency ejection, it is necessary to achieve a refill time equal to or less than 20 μs, and therefore, FIG. 19 shows the relationship between D2/D1 and T2/D2 at a refill time of 20 μs, as determined from FIG. 18. From the viewpoint of the stability of the ejection direction, it is necessary from a structural perspective that the relationship between the thickness T2 and the nozzle diameter D2 of the second nozzle plate 60, namely, the value of T2/D2, should be equal to or greater than 1. Therefore, from FIG. 19, the condition for achieving high-frequency driving is that the value of D2/D1 should be equal to or greater than 2.5, which is the same as the condition described above.

On the other hand, the upper limit of the nozzle diameter D2 in the second nozzle plate 60 is determined on the basis of the bubble infiltration characteristics, and in this respect, it should be no more than 5 times the nozzle diameter D1 in the first nozzle plate 59. Consequently, the range of the value of the nozzle diameter D2 in the second nozzle plate 60 should be no less than 2.5 times and no more than 5 times the nozzle diameter D1 in the first nozzle plate 59.

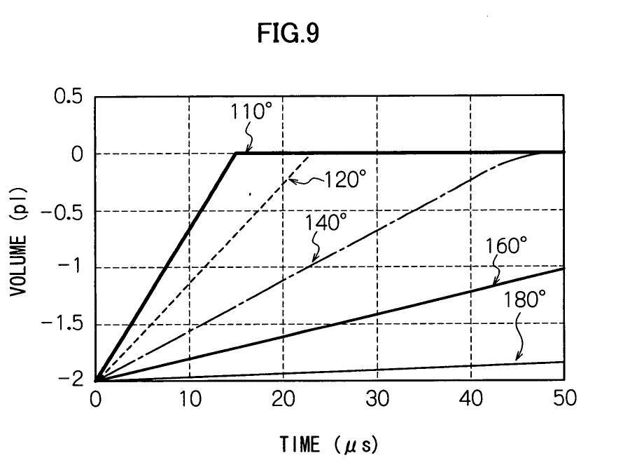

Next, the refilling characteristics in the case that the nozzle region in the second nozzle plate 60 has a tapered shape are described. The nozzle 51 of this kind is described with reference to FIG. 8. The nozzle 51 is formed in the first nozzle plate 59, which has the thickness T1 of 10 μm and is formed with a hole serving as the nozzle region of the nozzle diameter D1 of 10 μm, and the second nozzle plate 60, which has the thickness T2 of 30 μm and is formed with a hole serving as the nozzle region. The nozzle region of the second nozzle plate 60 has a tapered shape inclined at an angle of θ, and has the same diameter of 10 μm as the nozzle diameter D1 in the first nozzle plate 59 at the side in contact with the first nozzle plate 59. In other words, in a cross-section of the nozzle 51 along the liquid ejection direction, the angle formed between the nozzle region of the first nozzle 59 and the nozzle region of the second nozzle plate 60 is θ. If there is no second nozzle plate 60, then θ is 90°; and if it is 180° or greater, then ink supply becomes difficult. Consequently, the angle θ may take a value between 90° and 180°. In FIG. 8, the non-wetting region 61 and the wetting region 62 are not shown in the drawing. FIG. 9 shows the refilling characteristics in relation to variation in the angle θ.

As shown in FIG. 9, as the value of the angle θ becomes greater, the time required for refilling tends to become longer. As shown in FIG. 9, in the case of high-frequency driving at 40 kHz, the value of θ must be equal to or less than 120°. Consequently, the range of the value of θ for performing high-frequency driving is not greater than 90° and not less than 120°.

Below, an embodiment of the present invention is described.

### General Composition of Inkjet Recording Apparatus

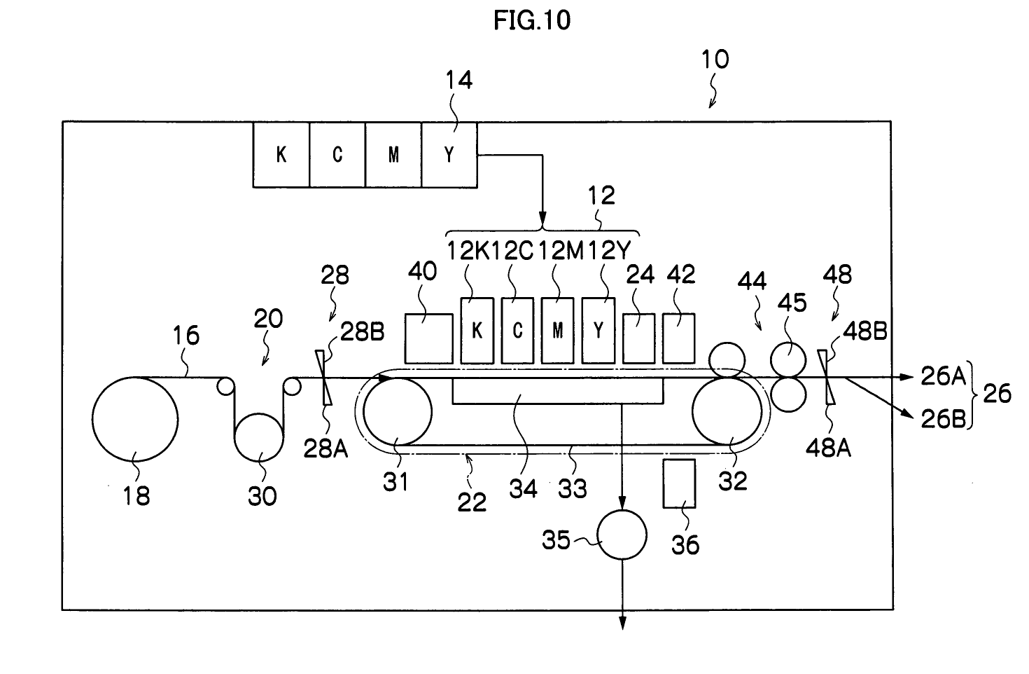

FIG. 10 is a general schematic drawing showing an inkjet recording apparatus forming an image forming apparatus according to an embodiment of the present invention. As shown in FIG. 10, the inkjet recording apparatus 10 includes: a printing unit 12 having a plurality of liquid ejection heads (hereinafter referred to as “head”) 12K, 12C, 12M and 12Y, provided for ink colors of black (K), cyan (C), magenta (M), and yellow (Y), respectively; an ink storing and loading unit 14 for storing inks of K, C, M and Y to be supplied to the heads 12K, 12C, 12M and 12Y; a paper supply unit 18 for supplying recording paper 16; a decurling unit 20 for removing curl in the recording paper 16; a suction belt conveyance unit 22 disposed facing the nozzle faces (ink ejection faces) of the heads 12K, 12C, 12M and 12Y, for conveying the recording paper 16 (recording medium) while keeping the recording paper 16 flat; a print determination unit 24 for reading the printed result produced by the printing unit 12; and a paper output unit 26 for outputting image-printed recording paper (printed matter) to the exterior.

In FIG. 10, a magazine for rolled paper (continuous paper) is shown as an embodiment of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 10, and the roll paper is cut to a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyance path. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the heads 12K, 12C, 12M and 12Y and the sensor face of the print determination unit 24 forms a plane.

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 10. The suction chamber 34 provides suction with a fan 35 to generate a negative pressure, and the recording paper 16 on the belt 33 is held by suction.

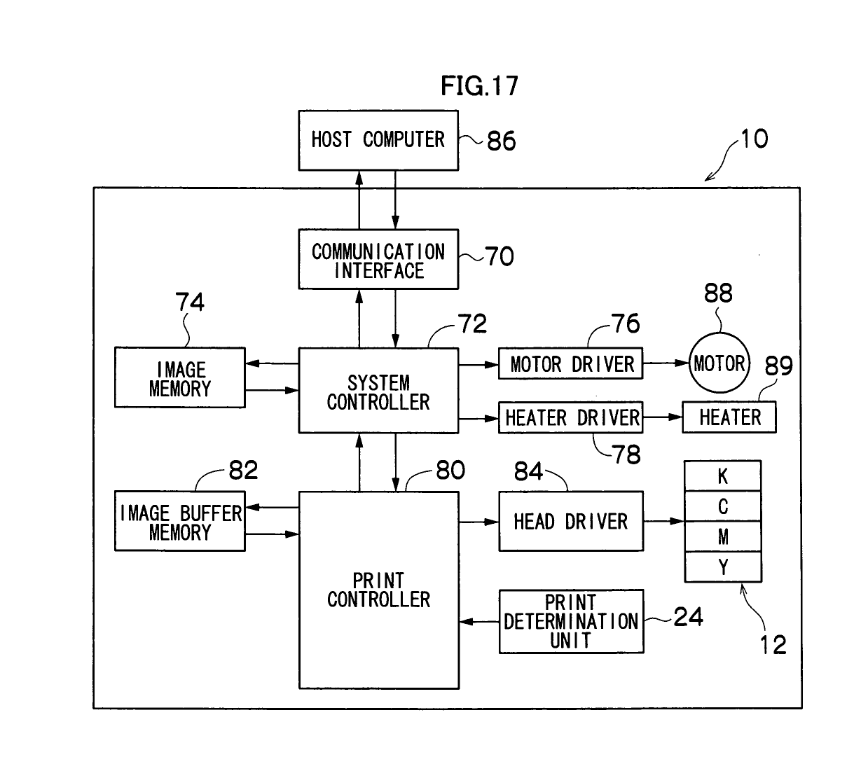

The belt 33 is driven in the clockwise direction in FIG. 10 by the motive force of a motor 88 (not shown in FIG. 10, but shown in FIG. 17) being transmitted to at least one of the rollers 31 and 32, which the belt 33 is set around, and the recording paper 16 held on the belt 33 is conveyed from left to right in FIG. 10.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, embodiments thereof include a configuration of nipping with a brush roller or a water absorbent roller or others, an air blow configuration in which clean air is blown, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can comprise a roller nip conveyance mechanism, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

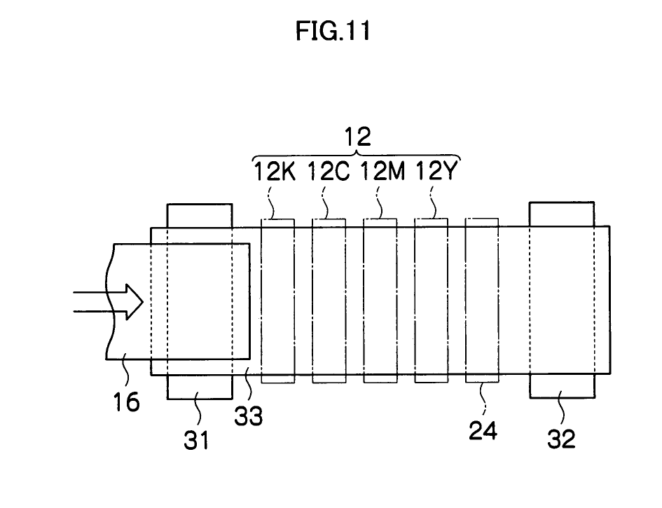

FIG. 11 is a principal plan diagram showing the periphery of the print unit 12 in the inkjet recording apparatus 10.

As shown in FIG. 11, the print unit 12 has a so-called “full line head” in which a line head having a length corresponding to the maximum paper width is arranged in a direction (main scanning direction) that is perpendicular to the paper feed direction (sub-scanning direction). Each of the heads 12K, 12C, 12M and 12Y constituting the print unit 12 is constituted by a line head, in which a plurality of ink ejection ports (nozzles) are arranged along a length that exceeds at least one side of the maximum-size recording paper 16 intended for use in the inkjet recording apparatus 10.

The heads 12K, 12C, 12M and 12Y are arranged in the order of black (K), cyan (C), magenta (M), and yellow (Y) from the upstream side (on the left-hand side in FIG. 10), along the feed direction of the recording paper 16. A color image can be formed on the recording paper 16 by ejecting the inks from the heads 12K, 12C, 12M and 12Y, respectively, onto the recording paper 16 while conveying the recording paper 16.

The print unit 12, in which the full-line heads covering the entire width of the paper are thus provided for the respective ink colors, can record an image over the entire surface of the recording paper 16 by performing the action of moving the recording paper 16 and the print unit 12 relative to each other in the paper conveyance direction just once (in other words, by means of a single sub-scan). Higher-speed printing is thereby made possible and productivity can be improved in comparison with a shuttle type head configuration in which a head moves reciprocally in the main scanning direction that is perpendicular to the paper conveyance direction.

Although the configuration with the KCMY four standard colors is described in the present embodiment, combinations of the ink colors and the number of colors are not limited to those. Light inks or dark inks can be added as required. For example, a configuration is possible in which heads for ejecting light-colored inks such as light cyan and light magenta are added.

As shown in FIG. 10, the ink storing and loading unit 14 has ink tanks for storing the inks of the colors corresponding to the respective heads 12K, 12C, 12M and 12Y, and the respective tanks are connected to the heads 12K, 12C, 12M and 12Y by means of channels (not shown). The ink storing and loading unit 14 has a warning device (for example, a display device, an alarm sound generator or the like) for warning when the remaining amount of any ink is low, and has a mechanism for preventing loading errors among the colors.

The print determination unit 24 has an image sensor (line sensor or the like) for capturing an image of the ink-droplet deposition result of the printing unit 12, and functions as a device to check for ejection defects such as clogs of the nozzles from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the heads 12K, 12C, 12M and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the heads 12K, 12C, 12M and 12Y for the respective colors, and the ejection of each head is determined.

The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in drawings, the paper output unit 26A for the target prints is provided with a sorter for collecting prints according to print orders.

Configuration of Liquid Ejection Head

Next, the structure of a head will be described. The heads 12K, 12C, 12M and 12Y of the respective ink colors have the same structure, and a reference numeral 50 is hereinafter designated to any of the heads.

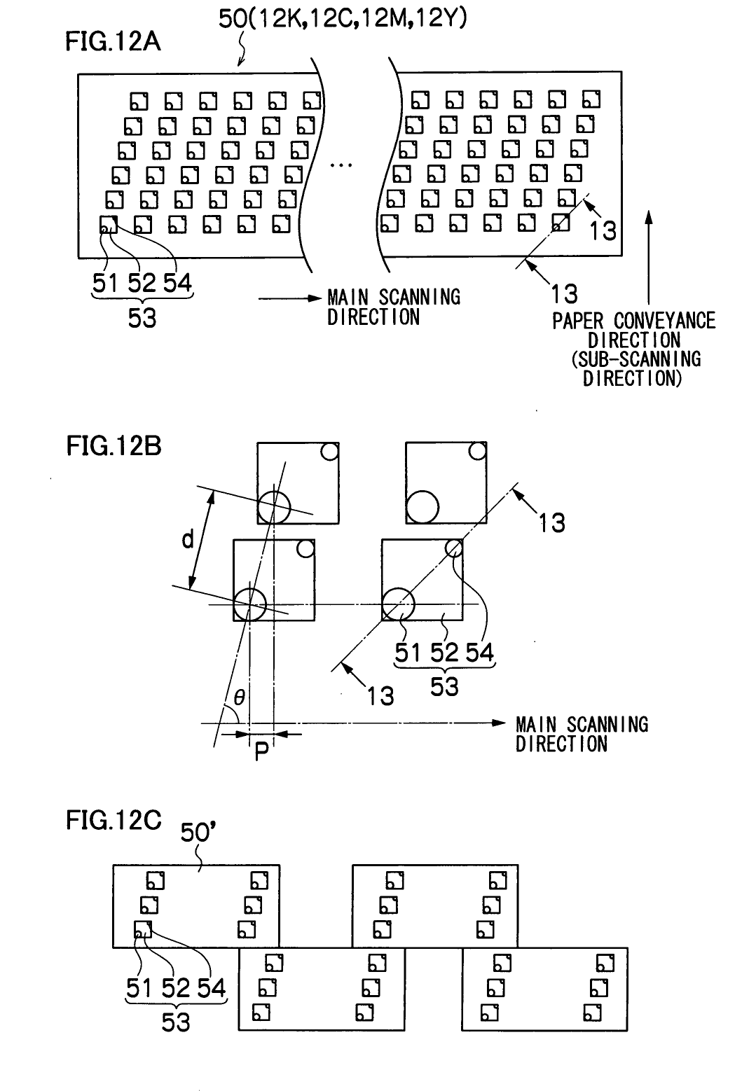

FIG. 12A is a perspective plan view showing an embodiment of the configuration of the head 50, FIG. 12B is an enlarged view of a portion thereof, FIG. 12C is a perspective plan view showing another embodiment of the configuration of the head 50.

The nozzle pitch in the head 50 should be minimized in order to maximize the resolution of the dots printed on the surface of the recording paper 16. As shown in FIGS. 12A to 12C, the head 50 according to the present embodiment has a structure in which a plurality of ink chamber units 53, each having a nozzle 51 forming an ink droplet ejection port, a pressure chamber (liquid chamber) 52, and a supply ports 54 corresponding to the nozzle 51, and the like, are disposed two-dimensionally in the form of a staggered matrix, and hence the effective nozzle interval (the projected nozzle pitch) as projected in the lengthwise direction of the head (the main scanning direction perpendicular to the paper conveyance direction) is reduced and high nozzle density is achieved.

The mode of forming one or more nozzle rows through a length corresponding to the entire width of the recording paper 16 in the main scanning direction substantially perpendicular to the conveyance direction is not limited to the embodiment described above. For example, instead of the configuration in FIG. 12A, as shown in FIG. 12C, a line head having nozzle rows of a length corresponding to the entire width of the recording paper 16 can be formed by arranging and combining, in a staggered matrix, short head blocks 50′ having a plurality of nozzles 51 arrayed in a two-dimensional fashion.

The present embodiment describes a mode in which the planar shape of the pressure chambers 52 is substantially a square shape, but the planar shape of the pressure chambers 52 is not limited to being a substantially square shape, and it is possible to adopt various other shapes, such as a substantially circular shape, a substantially elliptical shape, a substantially parallelogram (or rhombus) shape, or the like. Furthermore, the arrangement of the nozzles 51 and the supply ports 54 is not limited to the arrangement shown in FIGS. 12A to 12C, and it is also possible to arrange nozzles 51 substantially in the central region of the pressure chambers 52, or to arrange the supply ports 54 in the side walls of the pressure chambers 52.

As shown in FIG. 12B, the high-density nozzle head according to the present embodiment is achieved by arranging a plurality of ink chamber units 53 in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiment shown in the drawings, and it is also possible to apply various other types of nozzle arrangements, such as an arrangement structure having one nozzle row in the sub-scanning direction, a structure having nozzle rows arranged in a two-row staggered configuration, and the like.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording medium (the main scanning direction) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that shown in FIGS. 12A to 12C are driven, the main scanning according to the above-described (3) is preferred.

On the other hand, “sub-scanning” is defined as to repeatedly perform printing of one line (a line formed of a row of dots, or a line formed of a plurality of rows of dots) formed by the main scanning, while moving the full-line head and the recording paper 16 relatively to each other.

In the present embodiment, a full line head is described, but the scope of application of the present invention is not limited to this and it can also be applied to a serial type of head which carries out printing in the breadthways direction of the recording paper 16 while scanning a short head having nozzle rows of a length shorter than the width of the recording paper 16, in the breadthways direction of the recording paper 16.

As shown in FIGS. 12A to 12C, the pressure chamber 52 provided corresponding to each of the nozzles 51 is approximately square-shaped in plan view, and a nozzle 51 and a supply port 54 are formed respectively at either corner of a diagonal of the pressure chamber 52. The pressure chambers 52 are connected to a common flow channel (common liquid chamber), which is not illustrated, through the supply ports shown in FIGS. 12A and 12B. The common flow channel is connected to an ink supply tank which is not shown in the drawings, and the ink supplied from the ink supply tank is distributed and supplied to the respective pressure chambers 52 through the common flow channel.

### Structure of Liquid Ejection Head

Next, the detailed structure of the liquid ejection head is described with reference to FIG. 13.

FIG. 13 is a cross-sectional diagram along line 13-13 in FIGS. 12A and 12B, and shows the inner structure of the ink chamber unit 53 which corresponds to one nozzle.

As shown in FIG. 13, the pressure chamber unit 53 is formed by the pressure chamber 52 connected to the nozzle 51 which ejects the ink, and it is also connected to the common liquid chamber 55 which supplies the ink through the supply port 54. Furthermore, one surface (in the diagram, the ceiling) of the pressure chamber 52 is constituted by a diaphragm 56, and a piezoelectric element 58 (corresponding to a pressure generating device) which causes the diaphragm 56 to deform is bonded on top of the diaphragm 56, and an individual electrode 57 is formed on the upper surface of the piezoelectric element 58. Furthermore, the diaphragm 56 also serves as a common electrode. The nozzle 51 is formed in the first nozzle plate 59 and the second nozzle plate 60, and the nozzle diameter of the nozzle region formed in the first nozzle plate 59 is different to the nozzle diameter of the nozzle region in the second nozzle plate 60. In other words, the nozzles 51 are constituted by the nozzle plates in two steps, having different nozzle diameters. The first nozzle plate 59 has the thickness of 10 μm and the nozzle diameter of 10 μm, and the second plate 60 has the thickness of 30 μm and the nozzle diameter of 30 μm.

The piezoelectric element 58 is arranged between the common electrode (diaphragm 56) and the individual electrode 57, and it deforms when a drive voltage is applied between the common electrode (diaphragm 56) and the individual electrode 57. A structure is adopted in which the diaphragm 56 deforms due to the deformation of the piezoelectric element 58, thereby reducing the volume of the pressure chamber 52 and applying pressure to the ink inside the pressure chamber 52, and accordingly, the ink is ejected from the nozzle 51. When the voltage applied between the common electrode (diaphragm 56) and the individual electrode 57 is released, the piezoelectric element 58 returns to its original position, the volume of the pressure chamber 52 returns to its original size, and new ink is supplied into the pressure chamber 52 from the common liquid channel 55 and through the supply port 54.

FIG. 14 shows the change in the voltage applied to the piezoelectric element 58 arranged between the common electrode (diaphragm 56) and the individual electrode 57, when liquid is ejected from a nozzle 51 of the liquid ejection head. This waveform is for the push ejection method as described previously. Initially, in the state A, the voltage applied to the piezoelectric element 58 arranged between the common electrode (diaphragm 56) and the individual electrode 57 is gradually raised, in such a manner that a force acts in a direction for contracting the pressure chamber 52. Accordingly, the pressure of the liquid in the pressure chamber 52 is increased, and the free surface of the liquid is pushed out from the nozzle 51. Thereupon, in the state B, the voltage applied to the piezoelectric element 58 arranged between the common electrode (diaphragm 56) and the individual electrode 57 is kept at a uniform value, and the pressure chamber 52 is maintained in a compressed state. Finally, in the state C, the voltage applied to the piezoelectric element 58 arranged between the common electrode (diaphragm 56) and the individual electrode 57 is reduced gradually, in such a manner that a force acts in a direction for expanding the pressure chamber 52, thereby pulling the free surface of the liquid in the nozzle 51 toward the pressure chamber 52. By means of this series of actions, a liquid droplet is ejected from the nozzle 51. An image is formed by means of droplets of this kind landing on the recording medium, such as paper.

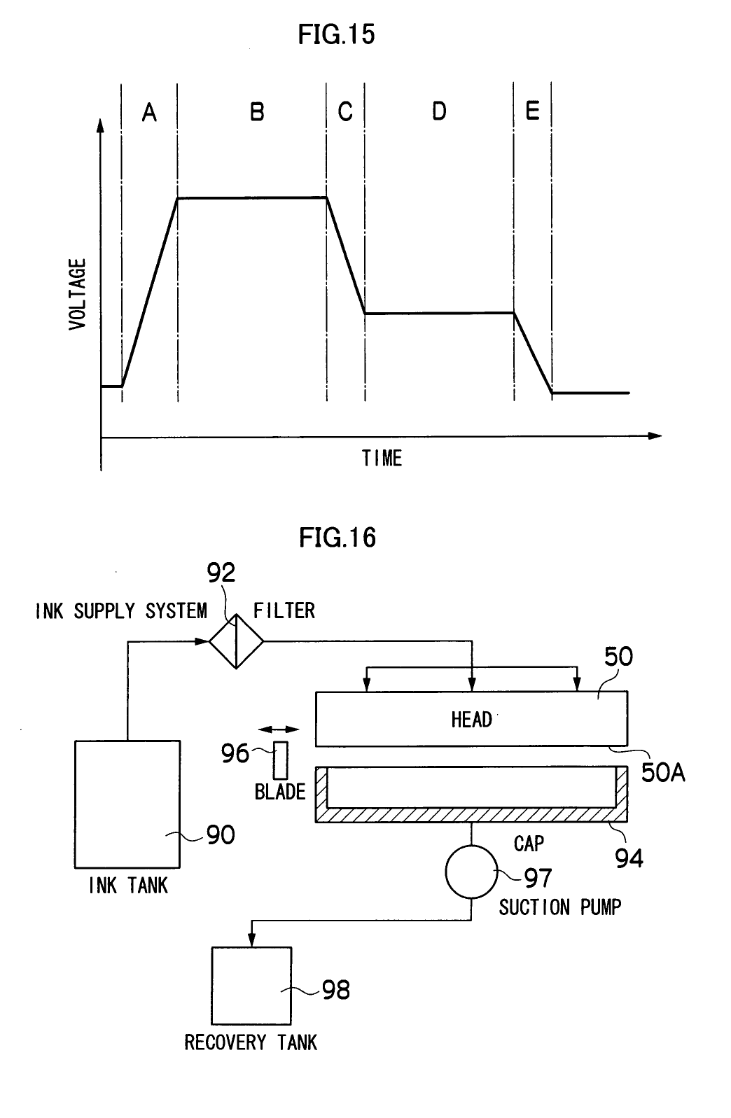

By dividing the expansion of the pressure chamber 52 in the state C, into two steps, as shown in FIG. 15, it is possible to keep the free surface of the liquid stable after the expansion. More specifically, a voltage is applied to the piezoelectric element 58 arranged between the common electrode (diaphragm 56) and the individual electrode 57, in order to achieve: contraction in the state A, maintenance in the state B, a first-step expansion in the state C, first-step expanded state maintenance in the state D, and a second-step expansion in the state E.

### Ejection Recovery Unit

FIG. 16 is a schematic drawing showing the configuration of the ink supply system in the inkjet recording apparatus 10. The ink tank 90 is a base tank that supplies ink to the print head 50 and is set in the ink storing and loading unit 14 described with reference to FIG. 10. The aspects of the ink tank 90 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink tank 90 in FIG. 16 is equivalent to the ink storing and loading unit 14 in FIG. 10 described above.

A filter 92 for removing foreign matters and bubbles is disposed in a pipe line that connects the ink tank 90 to the print head 50 as shown in FIG. 16. The filter mesh size is preferably equivalent to or less than the diameter of the nozzle of the print head 50 and commonly about 20 μm.

Although not shown in FIG. 16, it is preferable to provide a sub-tank integrally to the print head 50 or nearby the print head 50. The sub-tank has a damper function for preventing variation in the internal pressure of the head and a function for improving refilling of the print head.

The inkjet recording apparatus 10 is also provided with a cap 94 as a device to prevent the nozzles from drying out or to prevent an increase in the ink viscosity in the vicinity of the nozzles 51, and a cleaning blade 96 as a device to clean the nozzle face 50A.

A maintenance unit including the cap 94 and the cleaning blade 96 can be relatively moved with respect to the print head 50 by a movement mechanism (not shown), and is moved from a predetermined holding position to a maintenance position below the print head 50 as required.

The cap 94 is displaced upward and downward in a relative fashion with respect to the print head 50 by an elevator mechanism (not shown). When the power of the inkjet recording apparatus 10 is switched off or when the apparatus is in a standby state for printing, the elevator mechanism raises the cap 94 to a predetermined elevated position so as to make tight contact with the print head 50, and the nozzle region of the nozzle surface 50A is thereby covered by the cap 94.

The cleaning blade 96 is composed of rubber or another elastic member, and can slide on the ink ejection surface (nozzle surface 50A) of the print head 50 by means of a blade movement mechanism (not shown). If there are ink droplets or foreign matter adhering to the nozzle surface 50A, then the nozzle surface 50A is wiped by causing the cleaning blade 96 to slide over the nozzle surface 50A, thereby cleaning same.

During printing or during standby, if the use frequency of a particular nozzle 51 has declined and the ink viscosity in the vicinity of the nozzle 51 has increased, then a preliminary ejection is performed toward the cap 94, in order to remove the ink that has degraded as a result of increasing in viscosity.

In other words, when a state in which ink is not ejected from the print head 50 continues for a certain amount of time or longer, the ink solvent in the vicinity of the nozzles evaporates and ink viscosity increases. In such a state, ink can no longer be ejected from the nozzle 51 even if an actuator (the piezoelectric element 58) for the ejection driving is operated. Before reaching such a state (in a viscosity range that allows ejection by the operation of the piezoelectric element 58) the piezoelectric element 58 is operated to perform the preliminary discharge to eject the ink whose viscosity has increased in the vicinity of the nozzle toward the ink receptor. After the nozzle face 50A is cleaned by a wiper such as the cleaning blade 96 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

Moreover, when bubbles have become intermixed into the ink inside the print head 50 (the ink inside the pressure chambers 52), the cap 94 is placed on the print head 50, ink (ink in which bubbles have become intermixed) inside the pressure chambers 52 is removed by suction with a suction pump 97, and the ink removed by suction is sent to a recovery tank 98. This suction operation is also carried out in order to suction and remove degraded ink which has hardened due to increasing in viscosity when ink is loaded into the print head for the first time, and when the print head starts to be used after having been out of use for a long period of time.

More specifically, when bubbles have become intermixed into a nozzle 51 or a pressure chamber 52, or when the ink viscosity inside the nozzle 51 has increased over a certain level, ink can no longer be ejected from the nozzle 51 by means of a preliminary ejection by operating the piezoelectric element 58. In a case of this kind, a cap 94 is placed on the nozzle surface 50A of the print head 50, and the ink containing air bubbles or the ink of increased viscosity inside the pressure chambers 52 is suctioned by a pump 97.

However, since this suction action is performed with respect to all the ink in the pressure chambers 52, the amount of ink consumption is considerable. Therefore, a preferred aspect is one in which a preliminary discharge is performed when the increase in the viscosity of the ink is small. Furthermore, the cap 94 described in FIG. 16 not only function as a suction device by also functions as an ink receiver for preliminary ink ejection.

Moreover, desirably, the inside of the cap 94 is divided by means of partitions into a plurality of areas corresponding to the nozzle rows, thereby achieving a composition in which suction can be performed selectively in each of the demarcated areas, by means of a selector, or the like.

### Description of Control System

FIG. 17 is a principal block diagram showing the system configuration of the inkjet recording apparatus 10. The inkjet recording apparatus 10 includes a communication interface 70, a system controller 72, an image memory 74, a motor driver 76, a heater driver 78, a print controller 80, an image buffer memory 82, a head driver 84, and the like.

The communication interface 70 is an interface unit for receiving image data sent from a host computer 86. A serial interface such as USB (universal serial bus), IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the memory 74. The memory 74 is a storage device for temporarily storing images inputted through the communication interface 70, and data is written and read to and from the memory 74 through the system controller 72. The memory 74 is not limited to a memory composed of semiconductor elements, and a hard disk drive or another magnetic medium may be used.

The system controller 72 is a control unit for controlling the various sections, such as the communications interface 70, the memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the memory 74, or the like, it also generates a control signal for controlling the motor 88 of the conveyance system and the heater 89.

The motor driver (drive circuit) 76 drives the motor 88 in accordance with commands from the system controller 72. The heater driver 78 drives the heater 89 of the post-drying unit 42 (shown in FIG. 10) or the like in accordance with commands from the system controller 72.

The print controller 80 has a signal processing function for performing various tasks, compensations, and other types of processing for generating print control signals from the image data stored in the memory 74 in accordance with commands from the system controller 72 so as to supply the generated print control signal to the head driver 84. Prescribed signal processing is carried out in the print controller 80, and the ejection amount and the ejection timing of the ink droplets from the respective print heads 12 are controlled (droplet ejection control) through the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 17 is one in which the image buffer memory 82 accompanies the print controller 80; however, the memory 74 may also serve as the image buffer memory 82. Also possible is an aspect in which the print controller 80 and the system controller 72 are integrated to form a single processor.

The head driver 84 drives the piezoelectric elements 58 of the heads of the respective colors 12K, 12C, 12M and 12Y on the basis of print data supplied by the print controller 80. The head driver 84 can be provided with a feedback control system for maintaining constant drive conditions for the print heads.

The print determination unit 24 is a block that includes the line sensor as described above with reference to FIG. 10, reads the image printed on the recording paper 16, determines the print conditions (presence of the ejection, variation in the dot formation, and the like) by performing desired signal processing, or the like, and provides the determination results of the print conditions to the print controller 80. According to requirements, the print controller 80 makes various corrections with respect to the head 50 on the basis of information obtained from the print determination unit 24.

The system controller 72 and the print controller 80 may be constituted by one processor, and it is also possible to use a device which combines a system controller 72, a motor driver 76, and a heater driver 78, in a single device, or a device which combines a print controller 80 and a head driver in a single device.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head, comprising:
a nozzle plate formed with a nozzle through which a droplet of liquid is ejected;
a liquid chamber which contains the liquid and is connected to the nozzle; and
a pressure generating device which causes the liquid chamber to contract and expand, wherein:
the nozzle has a first portion having a first diameter on a side from which the liquid is ejected, and a second portion having a second diameter on a side from which the liquid is supplied from the liquid chamber, the second diameter being not less than 2.5 times and not more than 5 times the first diameter;
a non-wetting surface is formed on the nozzle plate at an inner face of the first portion of the nozzle and a face that contacts an outside air;
a wetting surface is formed on an inner face of the nozzle other than the inner face of the first portion; and
when starting ejection of the droplet of the liquid from the nozzle, force applied to the liquid inside the liquid chamber by the pressure generating device acts only in a direction which contracts volume inside the liquid chamber.

2. A liquid ejection head, comprising:
a nozzle plate formed with a nozzle through which a droplet of liquid is ejected;
a liquid chamber which contains the liquid and is connected to the nozzle; and
a pressure generating device which causes the liquid chamber to contract and expand, wherein:
the nozzle has a first portion having a first diameter on a side from which the liquid is ejected, and a second portion having a shape tapered from the liquid chamber to the first portion, an angle formed by an inner surface of the first portion and an inner surface of the second portion being not less than 90° and not more than 120°;
a non-wetting surface is formed on the nozzle plate at an inner face of the first portion of the nozzle and a face that contacts an outside air;
a wetting surface is formed on an inner face of the nozzle other than the inner face of the first portion; and
when starting ejection of the droplet of the liquid from the nozzle, force applied to the liquid inside the liquid chamber by the pressure generating device acts only in a direction which contracts volume inside the liquid chamber.

3. An image forming apparatus comprising the liquid ejection head as defined in claim 1.

4. An image forming apparatus comprising the liquid ejection head as defined in claim 2.
